(19) United States
(12) Patent Application Publication
(10) Pub. No.: US 2008/0164628 A1
(43) Pub. Date: Jul. 10, 2008

(54) Method of Manufacturing Anti-Bacteria Polyamide Fiber via High Speed Spinning

(75) Inventors: Xuan DU, Yingkou (CN); Lin ZOU, Yingkou (CN); Xiuying PAN, Yingkou (CN); Lipeng JIANG, Yingkou (CN); Qingfu MENG, Yingkou (CN); Aoxiang HU, Yingkou (CN); Junlong ZHANG, Yingkou (CN); Ke CHEN, Yingkou (CN)

Correspondence Address: SMITH, GAMBRELL & RUSSELL, 1130 CONNECTICUT AVENUE, N.W., SUITE 1130, WASHINGTON, DC, 20036, US

(73) Assignee: LIAONING YINZHU CHEMTEX GROUP CO., LTD., Yingkou (CN)

(21) Appl. No.: 11/855,268

(22) Filed: Sep. 14, 2007

(30) Foreign Application Priority Data
Jan. 9, 2007 (CN) 200710010030.0

(51) Int. Cl. B29B 9/06

(52) U.S. Cl. 264/13

(57) ABSTRACT

A method of manufacturing anti-bacteria polyamide fiber via high speed spinning disclosed a kind of method, which can make manufacturing anti-bacteria polyamide fiber via high-speed spinning realized, including the preparation of anti-bacteria particles and process of high-speed spinning. The preparation of anti-bacteria particles includes surface treatment of anti-bacteria agent and its process of preparation. Choose nano zeolite carrying silver ion as anti-bacteria agent, mix the anti-bacteria particles and polymer chips, after melting, produce anti-bacteria yarns via high speed spinning. The surface treatment to the anti-bacteria agent the invention can improve the spinnability of raw material and place foundation for realizing high speed spinning. Further more, for the spinning pack, adopt good quality mental powder as filtering and pressuring material and increase length diameter rate of hole of spinneret to lengthen the friction distance that the melt passing the spinneret holes in order to eliminate the inner energy of polymer, which prevent the melt from breaking cause by released inner energy while polymer bursting from the spinneret holes. The method described in the invention is simple and easy to implemented. High speed spinning realized by adopting this method, solve the problems of long process rout, low output and lower grade products caused by existing low-speed spinning and greatly increase the beneficial result of enterprise.

### FIELD OF THE INVENTION

The invention relates to a kind of method of manufacturing anti-bacteria polyamide fiber via high speed spinning process.

### BACKGROUND OF THE INVENTION

As the first synthetic fiber—polyamide in human history, the commodity names are PA6 (PA is abbreviation of polyamide) and PA66, which are widely applied in the fields of apparel, household decoration and industry with its three outstanding characteristics, good wearable, high tenacity and good resilience. Nowadays, with the increasingly improvement of living level, it requires high demand on underwear with performance of anti-bacteria, thus, anti-bacteria yarns emerge as the times requires. With the technical barrier, the exiting production process of anti-bacteria PA fibers has to be adopted low speed spinning process. Its operational path is long, the rate of output is low, and the grade of products is now high, also. Therefore, we say that producing anti-bacteria PA fibers via low speed spinning is not an ideal method.

### SUMMARY OF THE INVENTION

The purpose of the invention is to provide a method of manufacturing anti-bacteria PA fibers by adopting high speed spinning in order to solve the practical problem of the existed manufacturing method.

The technology program of the invention is as follows:

Mainly mix the PA particles with anti-bacteria agent with PA chips, and melt them, then, produce anti-bacteria PA fibers via high speed spinning from the melted polymers.

1. Preparation of Anti-Bacteria Particle

Firstly choose high-grade anti-bacteria agent which is nano inorganic salts carrying silver ion such as that zeolite carries silver ion, its particle diameter is 20-80 nm. Then, make surface treatment to anti-bacteria agent that is to pickle the anti-bacteria agent in water solution of treatment agent, the formula of such water solution is that:

| Component | Proportion by Weight (unit: kg) |
|---|---|
| Methylphenyl silicone oil | 8.0-12.0 |
| Dodecyl sodium sulfate | 0.5-2.0 |
| Water | 85-95 |

Method of Treatment:

Mix and pickle the water solution of treatment agent and anti-bacteria agent with the proportion of 100:5-8 proportion by weight, heat up to 80□, the pickling time is 30-60 min and then, filter and dry.

The Preparation Process of Anti-Bacteria Particles:

Put the surface treated anti-bacteria agent and PA chips with the weight proportion of 20-30:70-80 into double screw extruder to be melted and granulated under blending, and make anti-bacteria PA chip particle out with anti-bacteria particle. The blending granulation temperature of PA 6 anti-bacteria particle is 265-270□, the blending granulation temperature of PA66 anti-bacteria particle is 290-300□.

2. High Speed of Anti-Bacteria PA Fibers

The anti-bacteria fiber of this invention is composite with polyamide and inorganic silver anti-bacteria agent, the content of anti-bacteria agent occupies 0.5-3% of total weight of fiber, the content of the optimizing anti-bacteria agent is 1.0-2.0%. According to the content of anti-bacteria agent in finished fibers, the proportion of anti-bacteria particle and polyamide chip are calculated. The proportion of weight between polyamide chip and anti-bacteria particle is 9-10:1. After mixing the two materials by blender, to put the materials into dryer and blend and melt them through screw extruder. The blended and melted anti-bacteria polymer will be spun under high speed spinning via spinning pack, to cool by air then, cluster and finish under 3,900-4,300 m/min, and make out anti-bacteria PA POY.

The invention realizes high speed spinning through the followings:
a. Making surface treatment to the anti-bacteria agent. The involving of anti-bacteria agent causes the mechanical impurities increased inside the polymer, which bring impact and harm to the spinnability of yarns. In order to solve the problem mentioned above and achieve high-speed spinning, the surface of anti-bacteria agent is treated, for preventing nano-anti-bacteria agent from recondensing and increasing the affinity and compatibility of anti-bacteria agent and polymer and lightening the harm to spinnability brought by adding anti-bacteria agent.
b. Adopting high quality mental powder as filter and pressurizing material to spinning packs, such as P270 or P271. Further more, increase length diameter rate of the holes of spinneret from normal 1:1, 2:1 to 3:1 or 4:1, the optimization is 4:1. While the polymer going through the holes of spinneret, the pressure caused the internal energy of polymer increased. While the polymer going through the holes of spinneret, meantime, the internal energy releases. If the length diameter rate is small, the melted polymer is easy to swell and break, i.e. broken yarn, while releasing energy. In order to solve this problem, a method of increasing the length diameter rate of the holes of spinneret is adopted, which lengthen the friction distance to the wall of hole while the melted polymer through the holes of spinneret, so that to eliminate the inner energy and solve the problem of polymer to be broken due to releasing inner energy while polymer bursting. Consequently, increase spinnability and make the high-speed spinning realized.

Process Condition of High Speed Spinning of Anti-Bacteria PA

| Item | | Anti-bacteria PA 6 | Anti-bacteria PA 66 |
|---|---|---|---|
| Content of anti-bacteria agent | | 1-2% | 1-2% |
| Water content of chips and | | 700 □g/g | 1,200 □g/g |
| anti-bacteria particles after | | | |
| being dried | | | |
| Temperature of | Zone 1 | 265 □ | 295 □ |
| screw extruder | Zone 2 | 265 □ | 295 □ |
| | Zone 3 | 263 □ | 280 □ |
| | Zone 4 | 261 □ | 280 □ |
| | Zone 5 | 261 □ | 275 □ |

| | | |
|---|---|---|
| Spinning temperature | 261 □ | 275 □ |
| Spinning pressure | 14 mPa | 16 mPa |
| Winding speed | 3900-4300 m/min | 3900-4300 m/min |
| Metal powder | P270 or P271 | P270 or P271 |
| Length diameter rate of | 4:1 | 4:1 |
| holes of spinneret | | |

The invention is simple, just utilize existing equipment by adopting high speed spinning process condition to realize high speed spinning, which solve the problems of long operational path by adopting low speed spinning only, low output and low grade products. It greatly brings economic benefit to enterprise.

### DESCRIPTION OF THE INVENTION IN DETAIL

Formula of Water Solution of Treatment Agent for Anti-Bacteria Agent

| Component | Proportion by Weight (Unit: kg) |
|---|---|
| Methylphenyl silicone oil | 10 |
| Dodecyl sodium sulfate | j1.5 |
| Water | 88.5 |

Treatment Method of Anti-Bacteria Agent

Pickle 7 kg of anti-bacteria zeolite carried by silver with 20-80 nm diameter into 100 kg of treatment agent solution, heat up to 80°, after 45 minutes, filter and dry.

The preparation process of anti-bacteria particles:

Put the surface treated anti-bacteria agent and PA chips with the weight proportion of 30:70 into double screw extruder to be melted and granulated under blending. The blending granulation temperature of PA 6 anti-bacteria particle is 268□, the blending granulation temperature of PA66 anti-bacteria particle is 295□.

High Speed of Anti-Bacteria PA Fibers

By adopting normal production equipment, two materials of polyamide chip and anti-bacteria particle with the proportion of 9-10:1 were prepared and mixed by blender, then, put them into dryer, and spin under high speed via spinning pack after blending and melting through screw extruder, and then cool by air, cluster and finish under 3,900-4,300 m/min, and make out anti-bacteria PA POY. The metal powder used is P270. The length diameter rate of hole of spinneret is 4:1. The content of anti-bacteria agent in the fiber of the invention is 0.5-3% of the total weight of the fiber. The content of optimized anti-bacteria agent is 1.0-2.0%.

According to the standard of WHB3220-2002, the test result of anti-bacteria fiber is that:

| | | |
|---|---|---|
| Colibacillus 8099 | Bacteriostatic Rate | 99.99% |
| Staphylococcus Aureus ATCC6538 | Bacteriostatic Rate | 99.99% |
| Candida Albicans ATCC10231 | Bacteriostatic Rate | 99.99% |

The assessment result on bacteria repellence of woven according to the standard of FZ/T730233-2006 achieves AAA Grade.

What is claimed:

1. A method of manufacturing anti-bacteria polyamide fiber via high speed spinning, is to mix the polyamide particle with anti-bacteria agent and polymer chips, and melt, then, produce anti-bacteria polyamide fiber via high speed spinning, characterized in that:
Preparation of Anti-bacteria Particles
To choose high-grade anti-bacteria agent that is nano inorganic salts carrying silver ion, that is zeolite carries silver ion with particle diameter of 20-80 nm;
The formula of water solution of surface treatment agent of anti-bacteria agent:

| Component | Proportion by Weight (unit: kg) |
|---|---|
| Methylphenyl silicone oil | 8.0-12.0 |
| Dodecyl sodium sulfate | 0.5-2.0 |
| Water | 85-95 |

Method of Treatment:
Mix and pickle the water solution of treatment agent and anti-bacteria agent with the proportion of 100:5-8 by weight, heat up to 80°, the pickling time is 30-60 min and then, filter and dry;
The preparation process of anti-bacteria particles:
Put the surface treated anti-bacteria agent and PA chips with the weight proportion of 20-30:70-80 into double screw extruder to be melted and granulated under blending, and make anti-bacteria PA chip particle out with anti-bacteria particle; The blending granulation temperature of PA 6 anti-bacteria particle is 265-270□, the blending granulation temperature of PA66 anti-bacteria particle is 290-300□;
High Speed of Anti-bacteria PA Fibers:
Prepare polyamide chip and anti-bacteria particle with the proportion of 9-10:1 by weight and mix the two materials by blender, then, put into dryer, and after blending and melting through screw extruder, spin under high speed via spinning pack, and then cool by air, cluster and finish under 3,900-4,300 m/min, and make out anti-bacteria PA POY

2. The method according to the claim 1, characterized in that to choose metal powder P270 or P271 for the spinning pack.

3. The method according to the claim 1, characterized in that to adopt the 4:1 of length diameter rate of hole of spinneret on the spinning machine.
